(19) United States
(12) Patent Application Publication
(10) Pub. No.: US 2025/0097381 A1
(43) Pub. Date: Mar. 20, 2025

(54) CONTENT-ADAPTIVE FRAME-RATE UPCONVERSION FOR VIDEO CODING

(71) Applicant: QUALCOMM Incorporated, San Diego, CA (US)

(72) Inventors: Nitin Bandwar, San Diego, CA (US); Wesley Elizaga Jonson, San Diego, CA (US); David Hansen, Calgary (CA); Alireza Shoa Hassani Lashdan, Burlington (CA)

(21) Appl. No.: 18/468,042

(22) Filed: Sep. 15, 2023

(51) Int. Cl. H04N 7/01; G06T 5/40; G06T 7/20; H04N 19/172

(52) U.S. Cl. CPC H04N 7/0137; G06T 5/40; G06T 7/20; H04N 7/014; H04N 19/172

(57) ABSTRACT

An example device for upconverting video data includes a memory configured to store video data; and a processing system comprising one or more processors implemented in circuitry, the processing system being configured to: determine an amount of motion between a region of a first frame of the video data and a corresponding region of a second frame of the video data; determine a number of frames to interpolate between the first frame and the second frame according to the amount of motion; and interpolate the determined number of frames to upconvert the video data.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to frame-rate upconversion (FRUC), also referred to as frame-rate conversion (FRC). Frame-rate upconversion involves interpolating frames between two or more consecutive frames of video data to increase a playback framerate for the video data. For example, a 15 fps video stream can be upconverted to 30 fps, 60 fps, 120 fps, or the like. According to the techniques of this disclosure, the amount of upconversion to be performed (that is, the number of frames to be interpolated) may be based on characteristics of the video data itself.

In one example, an upconversion unit may receive two frames of video data and perform a motion search to determine displacement of blocks or pixels between the two frames, represented by motion vectors. The upconversion unit may then determine a number of frames to interpolate according to an amount of motion represented by one or more of the motion vectors. In one example, the upconversion unit may determine a maximum motion vector, and compare the length of the maximum motion vector to one or more thresholds. The upconversion unit may determine an amount of upconversion to perform based on which of the thresholds the length of the maximum motion vector exceeds, if any.

In another example, the upconversion unit may generate a histogram representing the various motion vectors for regions between the two frames. The histogram may include a plurality of bins, each representing lengths for the motion vectors. The values of each bin may represent a number of motion vectors having lengths according to the bins. The upconversion unit may include various profile definitions for the resulting histogram, where the profile definitions may be mapped to a number of frames to be interpolated. Thus, the various profiles may represent an amount of motion between the two consecutive frames.

In some examples, additional or alternative characteristics of the video data may be used, such as, for example, spatial resolution, playback speed, amount of battery power, processing power, or the like.

In one example, a method of upconverting video data includes: determining an amount of motion between a region of a first frame of video data and a corresponding region of a second frame of the video data; determining a number of frames to interpolate between the first frame and the second frame according to the amount of motion; and interpolating the determined number of frames to upconvert the video data

In another example, a device for upconverting video data includes: a memory configured to store video data; and a processing system comprising one or more processors implemented in circuitry, the processing system being configured to: determine an amount of motion between a region of a first frame of the video data and a corresponding region of a second frame of the video data; determine a number of frames to interpolate between the first frame and the second frame according to the amount of motion; and interpolate the determined number of frames to upconvert the video data.

In another example, a computer-readable storage medium has stored thereon instructions that, when executed, cause a processing system to: determine an amount of motion between a region of a first frame of video data and a corresponding region of a second frame of the video data; determine a number of frames to interpolate between the first frame and the second frame according to the amount of motion; and interpolate the determined number of frames to upconvert the video data.

In another example, a device for upconverting video data includes: means for determining an amount of motion between a region of a first frame of video data and a corresponding region of a second frame of the video data; means for determining a number of frames to interpolate between the first frame and the second frame according to the amount of motion; and means for interpolating the determined number of frames to upconvert the video data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder.

FIG. 3 is a block diagram illustrating an example video decoder.

FIG. 4 is a block diagram illustrating an example frame rate conversion (FRC) unit according to the techniques of this disclosure.

FIG. 5 is a conceptual diagram illustrating a variety of possible interpolation schemes that may be performed by a FRC unit according to the techniques of this disclosure.

FIG. 6 is a conceptual diagram illustrating an example set of input frames and a resulting set of output frames that may be interpolated according to the techniques of this disclosure.

FIGS. 7A, 7B, and 8 are conceptual diagrams illustrating examples of consecutive input frames and objects depicted in the input frames, as well as distances between the objects, and resulting numbers of interpolated frames, according to the techniques of this disclosure.

FIG. 9 is a flowchart illustrating an example method of interpolating frames of video data according to the techniques of this disclosure.

FIGS. 10A-10C are block diagrams illustrating various examples of devices that may include frame rate conversion (FRC) units according to the techniques of this disclosure.

### DETAILED DESCRIPTION

Frame rate conversion (FRC) may be performed to interpolate one or more frames between two consecutive frames of video data. FRC is a feature that allows for the upscaling of a lower frame rate video to a higher frame rate by inserting interpolated frames between received input frames. The video data may correspond to decoded frames of video data from an encoded bitstream, captured frames of video data, generated frames (e.g., frames generated using computer graphics), or the like. According to the techniques of this disclosure, characteristics of the video data itself may be used to determine an amount of upscaling to be performed.

As an example, a frame rate conversion (FRC) unit may receive two consecutive frames of video data. The FRC unit may then perform a motion search to determine an amount of motion between the two frames. In general, if there is a relatively fast-moving object in the scene, there may be a large amount of motion between the two frames. Likewise, if there is a large amount of motion, more interpolated frames may be desirable. By contrast, if there is a relatively small amount of motion due to no fast-moving objects in the scene, fewer frames may be interpolated, thereby reducing computational demands placed on the FRC unit. Thus, reducing the number of interpolated frames dynamically in this manner may reduce power consumption and improve processing performance without degrading user experience.

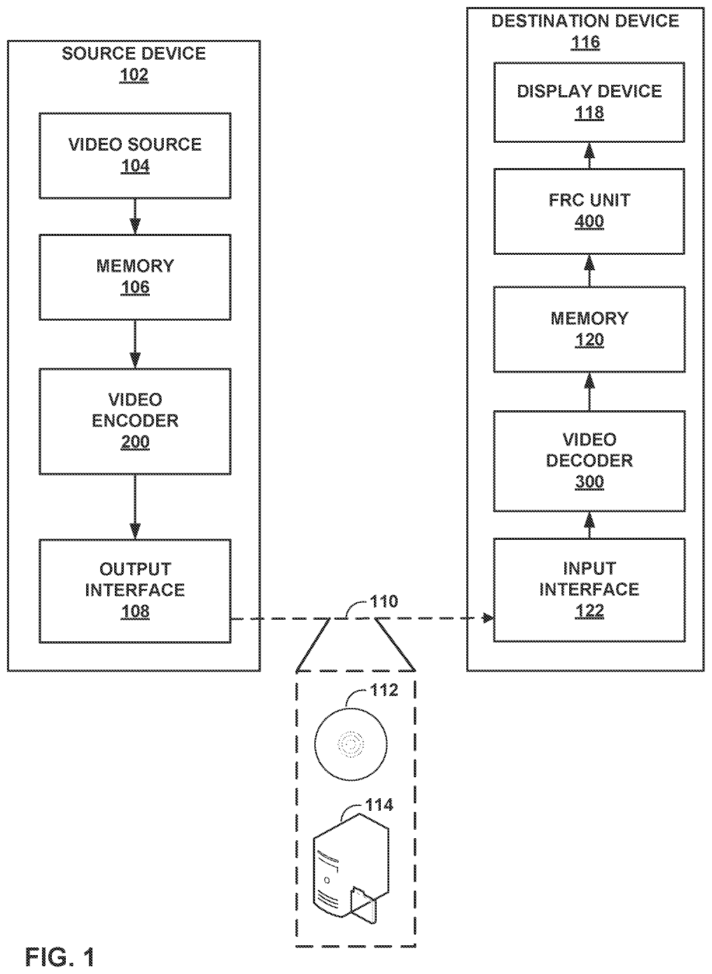

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, frame rate conversion (FRC) unit 400, and display device 118. In accordance with this disclosure, video encoder 200 of source device 102 and video decoder 300 of destination device 116 may be configured to apply the techniques for adaptive frame rate conversion. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for adaptive frame rate conversion. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, FRC unit 400 may be configured to perform the techniques of this disclosure in conjunction with any video coding techniques.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre-and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUS) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra-or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, FRC unit 400 may be configured to adaptively determine a number of frames to interpolate between two consecutive input frames based on characteristics of the two input frames. For example, FRC unit 400 may determine motion vectors for each block or other region of a later of the two frames, relative to matching blocks of the earlier of the two frames. FRC unit 400 may then determine an amount of motion between the two consecutive input frames, and determine a number of frames to interpolate between the two consecutive input frames according to the amount of motion.

In some examples, FRC unit 400 may then determine the amount of motion according to one of the motion vectors that is longest. FRC unit 400 may further compare the longest motion vector to one or more thresholds, which may each be associated with a different number of frames to be interpolated. For example, each of the thresholds may have a different value and mapped to a respective number of frames to be interpolated. Thus, for example, if the longest motion vector does not exceed any of the thresholds, FRC unit 400 may skip interpolation. As another example, if the longest motion vector exceeds an ordinal first threshold, FRC unit 400 may interpolate one frame. Continuing the example, if the longest motion vector exceeds an ordinal second threshold, which is longer than the ordinal first threshold, FRC unit 400 may interpolate two frames. As yet a further example, if the longest motion vector exceeds an ordinal third threshold, which is longer than the ordinal second threshold, FRC unit 400 may interpolate three frames. Additional thresholds with additional numbers of frames to be interpolated may be used as well.

As another example, FRC unit 400 may generate a histogram using the motion vectors. The histogram may have a set of bins representing different ranges of motion vector lengths, e.g., measured in pixel or sub-pixel accuracy magnitudes. The histogram may include, for each bin, a value representing a number of the motion vectors that is within the range of motion vector lengths represented by the bin. FRC unit 400 may further include configuration data defining various profiles for the shape of the resulting histogram. For example, a low motion profile may be defined where the histogram has a large number of zero-valued or very low-valued motion vectors. Thus, if the histogram satisfies the low motion profile (e.g., the bins for relatively low amounts of motion vectors have high values and other bins have low or zero values), FRC unit 400 may determine not to perform interpolation at all.

As another example, there may be a profile representing a small amount of high valued motion. Such a profile may indicate that most of the vectors have small lengths, but there are a few relatively long motion vectors. This profile may indicate that two or three frames are to be interpolated between the two consecutive input frames.

As still another example, there may be a midrange global motion profile, in which the bins representing mid-length motion vectors have high values, but the bins for the short and long motion vectors have values of zero or relatively small values. Such a profile may be mapped to interpolating one or two frames between the two consecutive input frames.

In some examples, the profiles for the histograms may be defined as thresholds for the bin values. For example, if the histogram has a value for a bin representing a relatively long motion vectors that exceeds a threshold, this may be mapped to interpolating three frames. As another example, if the histogram has a value for a bin representing mid length motion vectors that exceeds a threshold but the bin representing the relatively long motion vectors does not exceed its own threshold, this may be mapped to interpolating two frames. As still a further example, if the histogram has a value for a bin representing short length motion vectors that exceeds a threshold but the bins representing mid length and long motion vectors do not exceeds their corresponding thresholds, this may be mapped to interpolating a single frame.

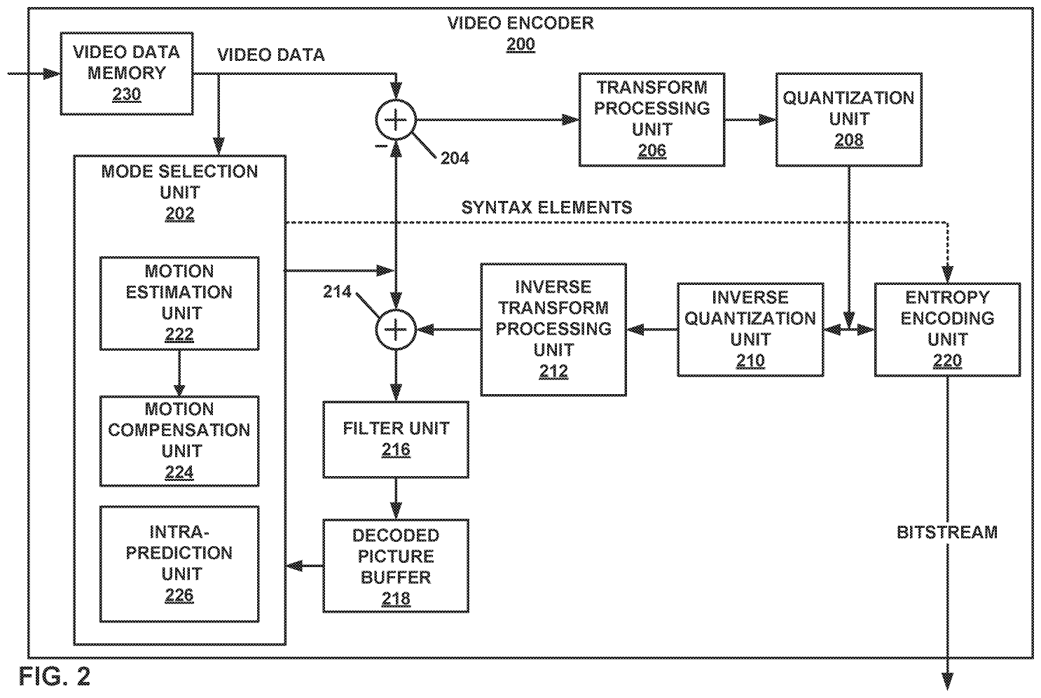

FIG. 2 is a block diagram illustrating an example video encoder 200. FIG. 2 is provided for purposes of explanation and should not be considered limiting of the techniques as broadly exemplified and described in this disclosure. For purposes of explanation, this disclosure describes video encoder 200 according to the techniques of VVC (ITU-T H.266, under development) and HEVC (ITU-T H.265). However, the techniques of this disclosure may be performed in conjunction with video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

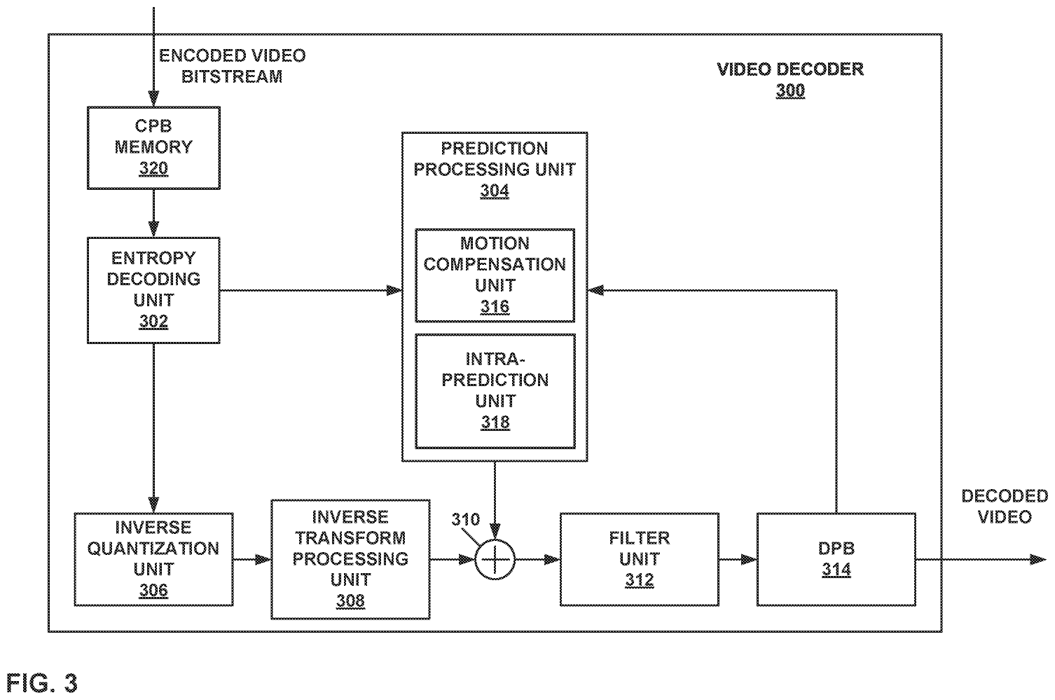

FIG. 3 is a block diagram illustrating an example video decoder 300. FIG. 3 is provided for purposes of explanation and is not limiting on the techniques as broadly exemplified and described in this disclosure. For purposes of explanation, this disclosure describes video decoder 300 according to the techniques of VVC (ITU-T H.266, under development) and HEVC (ITU-T H.265). However, the techniques of this disclosure may be performed in conjunction with video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

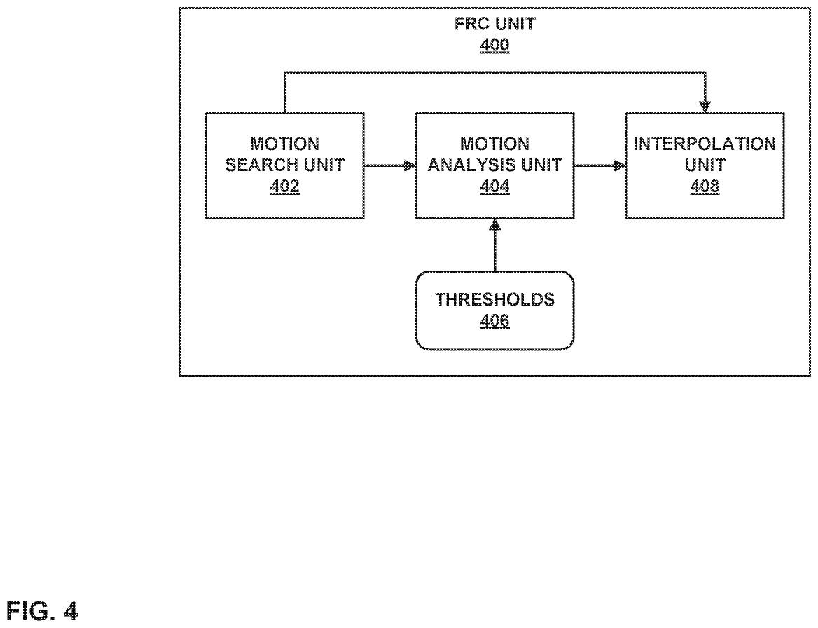

FIG. 4 is a block diagram illustrating an example frame rate conversion (FRC) unit according to the techniques of this disclosure. In this example, FRC unit 400 includes motion search unit 402, motion analysis unit 404, and interpolation unit 408. Motion search unit 402 may perform a motion search between two input frames to determine, for each block or other region of the first input frame, a closest matching block or other region of the second input frame. The blocks or regions may have predefined sizes, e.g., 4×4 pixels, 8×8 pixels, 16×16 pixels, etc. Alternatively, the blocks or regions may have variable sizes similar to CUs as discussed above.

As a result of the motion search, motion search unit 402 may determine a series of motion vectors for the pair of input frames. In some examples, the motion search may include partitioning the second input frame into a set of blocks or other regions. Motion search unit 402 may calculate a motion vector for each block or region using a motion search, where motion search unit 402 may search for a closest matching block or region in the first frame according to a difference measurement, such as sum of absolute differences (SAD), sum of squared differences (SSD), mean absolute difference (MAD), mean squared differences (MSD), or the like. In some examples, motion search unit 402 may represent an artificial intelligence/machine learning (AI/ML) unit trained to calculate motion between two consecutive frames, rather than using a traditional motion search algorithm.

Motion analysis unit 404 may determine which of the motion vectors is longest, that is, has a greatest magnitude. Motion analysis unit 404 may compare the longest motion vector to thresholds 406. Motion analysis unit 404 may then determine which of thresholds 406, if any, the longest motion vector exceeds. Then motion analysis unit 404 may determine a number of frames to be interpolated that is mapped to the longest of thresholds 406 exceeded by the longest motion vector.

Thresholds 406 may be defined in units of pixels (or samples), or sets of pixels/samples. For example, thresholds 406 may include a threshold of 2 pixels, a threshold of 6 pixels, and a threshold of 10 pixels. In this example, if the longest motion vector has a magnitude greater than 2 and less than 6, one frame may be interpolated; if the longest motion vector has a magnitude greater than 6 and less than 10, two frames may be interpolated; and if the longest motion vector has a magnitude greater than 10, three frames may be interpolated. Other thresholds may be defined. In some examples, the thresholds may be defined dynamically.

As another example, as noted above, motion analysis unit 404 may be configured to generate a histogram representing a motion field for a plurality of motion vectors calculated for regions between the first and second consecutive input frames. The histogram may include a set of bins, each representing a different range of motion vector lengths. Motion analysis unit 404 may calculate values for each bin representing the number of motion vectors having a length within the range corresponding to the bin. In this case, thresholds 406 may be assigned to the bins. For example, there may be a long motion vector bin and a long motion vector threshold, such that if the value of the long motion vector bin exceeds the long motion vector threshold, motion analysis unit 404 determines to interpolate three frames. Thresholds 406 may also include a mid length motion vector threshold, such that if the value of a mid length motion vector bin exceeds the mid length motion vector threshold but the long motion vector bin value does not exceed the long motion vector threshold, motion analysis unit 404 may determine to interpolate two frames. As another example, thresholds 406 may include a short motion vector threshold, such that if the value of a short motion vector bin exceeds the short motion vector threshold but the mid and long motion vector bins do not exceed the mid and long motion vector thresholds respectively, motion analysis unit 404 may determine to only interpolate one motion vector.

After motion analysis unit 404 has determined the number of frames to be interpolated, interpolation unit 408 may interpolate the determined number of frames from the two input frames. Motion search unit 402 may provide the calculated motion vectors to interpolation unit 408. Interpolation unit 408 may use the motion vectors to determine positions for blocks or other regions in interpolated frames according to the upconverted frame rate and the lengths of the motion vectors. For example, if one frame is to be interpolated, interpolation unit 408 may position an object in the interpolated frame at approximately half way along the motion vector. As another example, if two frames are to be interpolated, interpolation unit 408 may determine a first position in a first interpolated frame at about one-third of the way along the motion vector and a second position in a second interpolated frame at about two-thirds of the way along the motion vector.

In this manner, interpolation unit 408 may use the motion information from the motion vectors to predict where each pixel in an image may move, and generates interpolated frames including the predicted pixels. Interpolation unit 408 may then insert the interpolated frames between the input pair of frames, which may give the effect of a video with a higher frame rate while still preserving smooth, natural motion.

While conventional upscaling techniques use a pre-defined, fixed output frame rate, FRC unit 400 may dynamically determine an amount of frames to interpolate based on, e.g., the amount of motion between two input frames. In some examples, this determination may further be based on a maximum framerate of a display, an amount of battery power available to the device, the spatial resolution of the input video data, or the like. FRC unit 400 may in this manner preserve smooth motion for slower moving objects with smaller framerates, whereas for faster moving objects, more frames can be interpolated to obtain smooth motion. Thus, motion jitter can be avoided for fast moving objects, while reducing processing cycles and battery consumption for slower moving objects.

By contrast, when output framerate is fixed as in conventional techniques, if the output framerate is higher than necessary, system resources such as power, storage, computation cycles, and the like may be wasted without adding image quality benefits for slow moving objects. Likewise, image quality may be reduced when using a fixed framerate that is lower than needed for fast moving objects, because objects that move fast on screen require a higher framerate to avoid jitters.

Accordingly, by providing a dynamically determined number of interpolated frames, FRC unit 400 may conserve system resources such as computation cycles, storage, and memory, without adversely impacting image quality for slow moving objects, while also avoiding image quality issues for fast moving objects.

Thresholds 406 and corresponding numbers of frames may be stored in any of a variety of computer-readable media, such as, for example, dynamic random access memory (DRAM), including synchronous DRAM (SDRAM), magnetoresistive RAM (MRAM), resistive RAM (RRAM), or other types of memory devices. Each of motion search unit 402, motion analysis unit 404, and/or interpolation unit 408 may be implemented in hardware, software, firmware, or any combination thereof. When implemented in software or firmware, requisite processing circuitry (e.g., memory to store instructions and one or more processors to execute the instructions) may also be provided. Processing circuitry may include fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

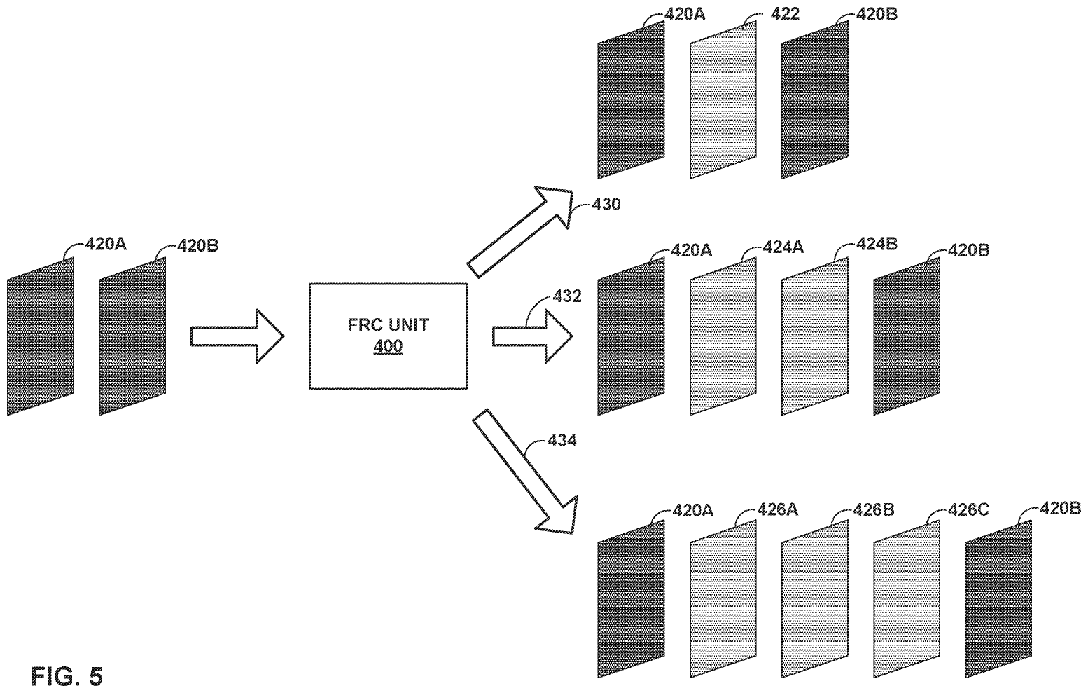

FIG. 5 is a conceptual diagram illustrating a variety of possible interpolation schemes that may be performed by FRC unit 400. In this example, FRC unit 400 receives two input frames 420A, 420B. FRC unit 400 may perform a motion search between input frames 420A, 420B to determine motion vectors representing blocks of, e.g., input frame 420B and corresponding (i.e., best-matching) blocks in input frame 420A. FRC unit 400 may then determine which of the motion vectors is longest, e.g., has a greatest magnitude. FRC unit 400 may then compare the longest motion vector to various thresholds.

In this example, if the longest motion vector exceeds a first threshold, FRC unit 400 performs path 430, in which FRC unit 400 interpolates interpolated frame 422. If the longest motion vector exceeds a second threshold, which is longer than the first threshold, FRC unit 400 interpolates interpolated frames 424A and 424B. If the longest motion vector exceeds a third threshold, which is longer than the second threshold, FRC unit 400 interpolates interpolated frames 426A-426C. If the longest motion vector does not exceed the first threshold, FRC unit 400 may skip interpolation of any frames between input frames 420A, 420B.

In these examples, if the original input video data is 30 fps (frames per second), by following path 430, the 30 fps video may be upconverted to 60 fps. By following path 432, the 30 fps video may be upconverted to 90 fps. By following path 434, the 30 fps video may be upconverted to 120 fps. The original video may have other frame rates as well, e.g., 15 fps, which may be upconverted to 30, 45, or 60 fps (or more); 60 fps, which may be upconverted to 120 fps, 240 fps, or 480 fps (or more); and so on. These techniques can be implemented with any number of thresholds and any framerate granularity.

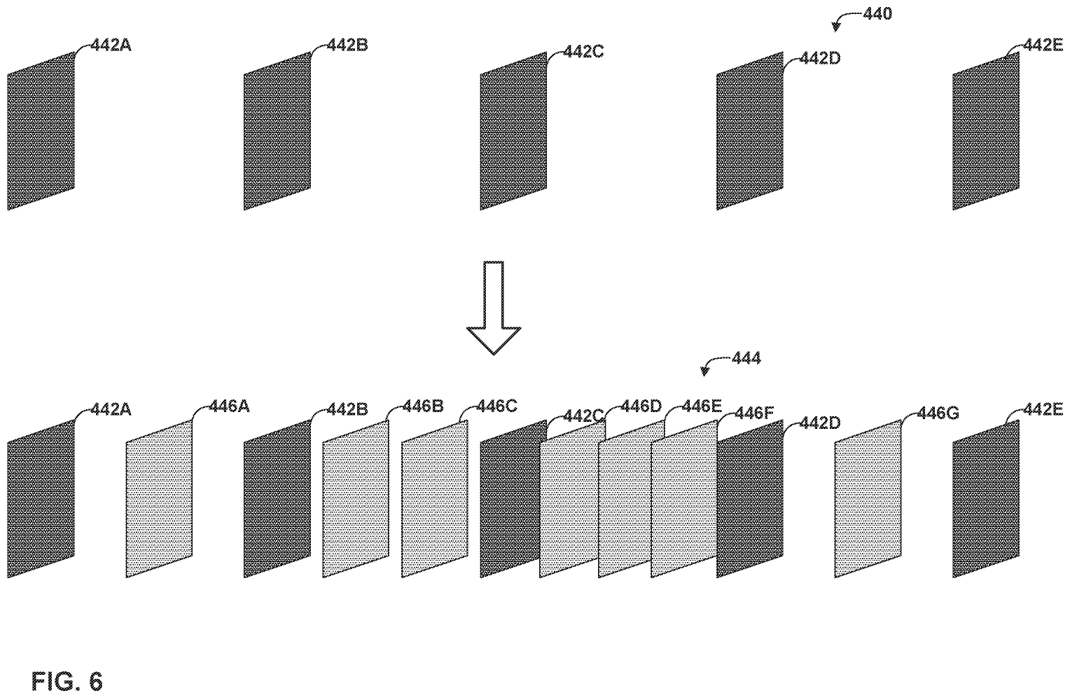

FIG. 6 is a conceptual diagram illustrating an example set of input frames 440 and a resulting set of output frames 444. In this example, input frames 440 include frames 442A-442E (frames 442). FRC unit 400 may perform the techniques of this disclosure on each consecutive pair of frames 442.

In the example of FIG. 6, FRC unit 400 performs a motion search between frames 442A and 442B and determines, based on a longest resulting motion vector, that only a single frame is to be interpolated (e.g., based on a comparison of the longest motion vector to a series of threshold values). Thus, FRC unit 400 interpolates interpolated frame 446A between frames 442A and 442B.

Additionally, in this example, FRC unit 400 performs a motion search between frames 442B and 442C and determines, based on a longest resulting motion vector, that two frames are to be interpolated (e.g., based on a comparison of the longest motion vector to the series of threshold values). Thus, FRC unit 400 interpolates interpolated frames 446B and 446C between frames 442B and 442C.

Furthermore, in this example, FRC unit 400 performs a motion search between frames 442C and 442D and determines, based on a longest resulting motion vector, that three frames are to be interpolated (e.g., based on a comparison of the longest motion vector to the series of threshold values). Thus, FRC unit 400 interpolates interpolated frames 446D, 446E, and 446F between frames 442C and 442D.

Finally, in this example, FRC unit 400 performs a motion search between frames 442D and 442E and determines, based on a longest resulting motion vector, that only a single frame is to be interpolated (e.g., based on a comparison of the longest motion vector to a series of threshold values). Thus, FRC unit 400 interpolates interpolated frame 446G between frames 442D and 442E.

Thus, as can be seen in the example of FIG. 6, according to the techniques of this disclosure, FRC unit 400 may be configured to dynamically and adaptively determine a number of frames to be interpolated based on characteristics of two consecutive input frames. By dynamically adjusting the frame rate based on relative motion, FRC unit 400 may only need to interpolate larger number of frames if there is significant motion between the two input frames. In periods of minimal to no motion, FRC unit 400 may use the native frame rate or only interpolate a small number of interpolated frames, which can save power, memory resources, and computation cycles. Furthermore, the target framerate can be refined for every input frame pair of an input sequence.

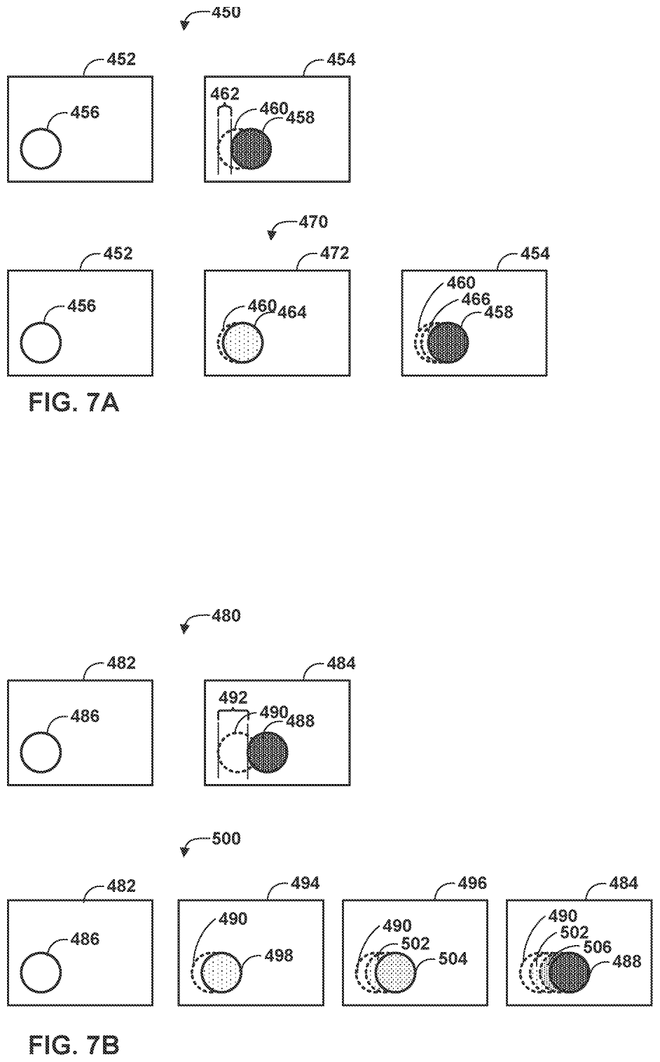

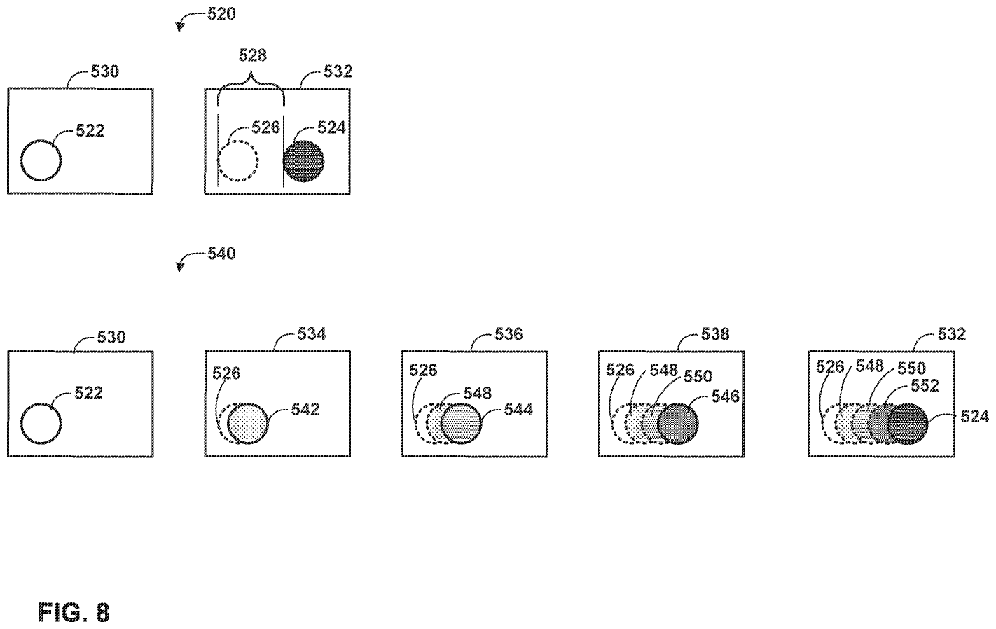

FIGS. 7A, 7B, and 8 are conceptual diagrams illustrating examples of consecutive input frames and objects depicted in the input frames, as well as distances between the objects, and resulting numbers of interpolated frames. In the example of FIG. 7A, input 450 includes input frames 452 and 454. Input frame 452 depicts an object at position 456, and input frame 454 depicts the same object at position 458. Position 460 represents position 456 in frame 454 for ease of comparison. As can be seen, the distance between positions 460 and 458 is distance 462. Thus, a motion vector representing the difference between position 458 and position 456 would have a length corresponding to distance 462. In this example, it is assumed that this is the longest motion vector, and that the longest motion vector exceeds a threshold mapped to a single frame to be interpolated.

Thus, as a result, FRC unit 400 may interpolate frame 472 between input frames 452 and 454. Through interpolation, the object may be depicted at position 464 of frame 472. Position 466 in frame 454 represents position 464 of interpolated frame 472. Thus, in this example, position 464 is approximately half way between positions 456 and 458. FRC unit 400 may generate output 470 including frame 452, interpolated frame 472, and frame 454.

FIG. 7B, as another example, depicts input 480 including input frames 482 and 484. Input frame 480 depicts an object at position 486, while input frame 484 depicts the object at position 488. Position 490 represents position 486 in frame 484 for ease of comparison. As can be seen, in this example, distance 492 between positions 490 and 488 is greater than distance 462 of FIG. 7A.

Thus, assuming that a longest motion vector representing distance 492 exceeds a different threshold mapped to two frames to be interpolated, FRC unit 400 interpolates interpolated frames 494 and 496 in this example. As shown, interpolated frame 494 depicts the object at position 498, while interpolated frame 496 depicts the object at position 504. Position 502 represents position 498 in interpolated frame 496 and frame 484, while position 506 represents position 504 in frame 484. Thus, position 498 is approximate one-third of the way between positions 486 and 488, while position 504 is approximate two-thirds of the way between positions 486 and 488. FRC unit 400 generates output including input frames 482 and 484 and interpolated frames 494 and 496, in this example.

FIG. 8, as yet a further example, depicts input 520 including input frames 530 and 532. Input frame 530 depicts the object at position 522, while input frame 532 depicts the object at position 524. Position 526 represents position 522 in input frame 532. Distance 528 between positions 526 and 524 is greater still than distance 492 in the example of FIG. 7B. Thus, assuming a longest motion vector corresponding to distance 528 exceeds yet another of the thresholds that is mapped to three interpolated frames, FRC unit 400 may generate output 540 including input frames 530 and 532 and three interpolated frames, i.e., interpolated frames 534, 536, and 538.

In this example, interpolated frame 534 depicts the object at position 542, interpolated frame 536 depicts the object at position 544, and interpolated frame 538 depicts the object at position 546. Position 548 represents position 542 in interpolated frames 536 and 538 and input frame 532. Position 550 represents position 544 in interpolated frame 538 and input frame 532. Position 552 represents position 546 in input frame 532.

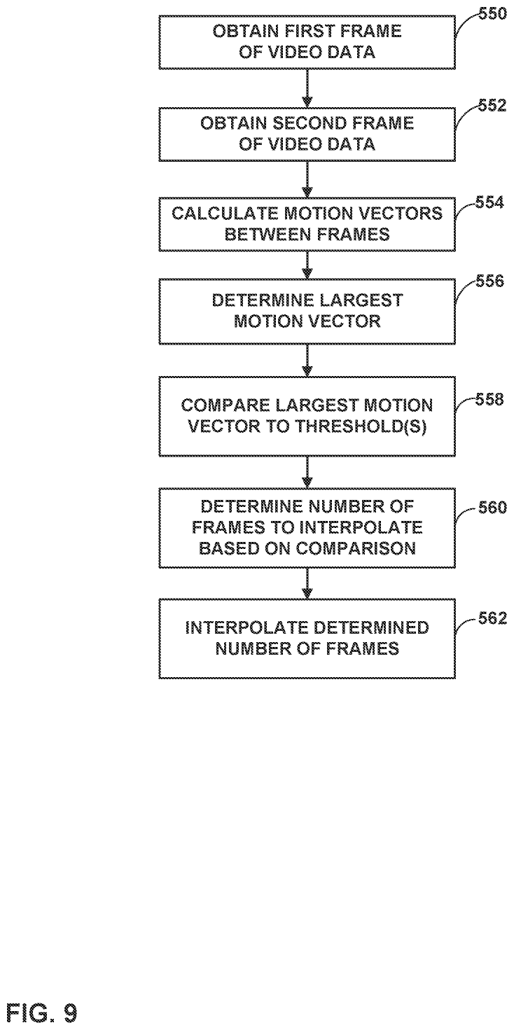

FIG. 9 is a flowchart illustrating an example method of interpolating frames of video data according to the techniques of this disclosure. The method of FIG. 9 may be performed by, e.g., FRC unit 400 of FIG. 4.

Initially, FRC unit 400 obtains a first frame of video data (560) and a second frame of video data (562). The first frame and the second frame may be consecutive frames of video data, such that the input video data does not include any frames in display order between the first and second frames. The terms “first” and “second” are used in the nominal sense in this case, as opposed to the ordinal sense, as the first frame may occur in the middle of the video data and the second frame may be the frame immediately following the first frame.

FRC unit 400 may then calculate motion vectors between the first and second frames (564). For example, FRC unit 400 may partition the second frame into a set of blocks or other regions of fixed or variable sizes. For each block or region of the second frame, FRC unit 400 may perform a motion search in the first frame to identify a closest matching block, which may be determined according to a difference metric such as sum of absolute difference (SAD), sum of squared difference (SSD), mean absolute difference (MAD), mean squared difference (MSD), or the like.

After calculating motion vectors for each block or region of the second frame, FRC unit 400 may determine which of the motion vectors is the largest motion vector (566). For example, FRC unit 400 may determine which of the motion vectors has a greatest magnitude.

FRC unit 400 may then compare the largest motion vector to one or more thresholds (568). The thresholds may be arranged in order such that each threshold has a unique value. Furthermore, the thresholds may each be mapped to a number of frames to interpolate. FRC unit 400 may compare the largest motion vector to the largest threshold and determine whether the largest motion vector is larger than the largest threshold. If the largest motion vector is not larger than the largest threshold, FRC unit 400 may determine whether the largest motion vector is larger than the next largest threshold (smaller than the largest threshold), and so on.

FRC unit 400 may then determine a number of frames to interpolate based on the comparison of the largest motion vector to the thresholds (570). After determining one of the thresholds (if any) that the largest motion vector exceeds without exceeding a subsequently larger threshold, FRC unit 400 may determine that the number of frames to interpolate is the number to which the one of the thresholds is mapped.

For example, there may be three thresholds: a smallest threshold mapped to one interpolated frame, a medium threshold mapped to two interpolated frames, and a largest threshold mapped to three interpolated frames. If the largest motion vector exceeds the largest threshold, FRC unit 400 may determine to interpolate three frames. If the largest motion vector exceeds the medium threshold but not the largest threshold, FRC unit 400 may determine to interpolate two frames. If the largest motion vector exceeds the smallest threshold but not the medium threshold, FRC unit 400 may determine to interpolate one frame. If the largest motion vector does not exceed the smallest threshold, FRC unit 400 may determine to interpolate no frames.

After determining the number of frames to interpolate, FRC unit 400 may interpolate the determined number of frames (572).

In this manner, the method of FIG. 9 represents an example of a method of upconverting video data including determining an amount of motion between a region of a first frame of video data and a corresponding region of a second frame of the video data; determining a number of frames to interpolate between the first frame and the second frame according to the amount of motion; and interpolating the determined number of frames to upconvert the video data.

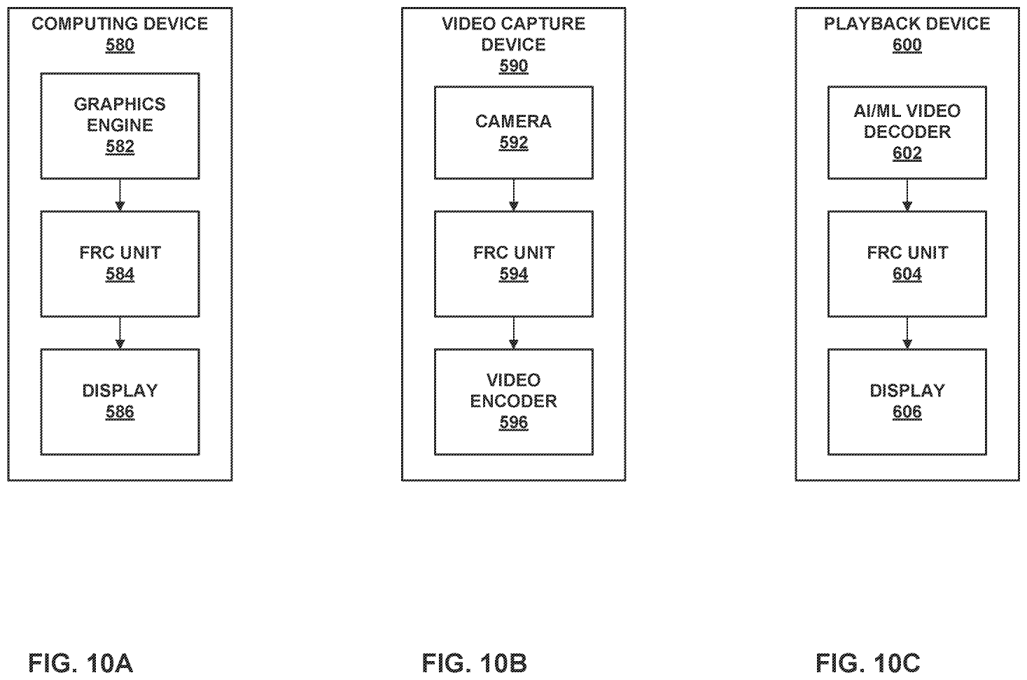

FIGS. 10A-10C are block diagrams illustrating various examples of devices that may include frame rate conversion (FRC) units according to the techniques of this disclosure. FIG. 10A depicts computing device 500 including graphics engine 582, FRC unit 584, and display 586. In this example, graphics engine 582 generates a series of frames of video data using three-dimensional graphics data, which may be defined by virtual objects in a virtual scene. The virtual objects may be defined by sets of points and edges between the points, as well as attribute data associated with the points, edges, faces defined by the edges, or the like. Such attributes may include colors, reflectiveness, surface normal values, or other such attributes. After rendering a set of two consecutive frames, FRC unit 584 may perform the techniques of this disclosure to interpolate a dynamically determined number of frames between the two consecutive frames (e.g., based on an amount of motion between the two consecutive frames). FRC unit 584 may provide the interpolated frames and the input frames, in display order, to display 586. Display 586 may operate at a particular framerate. If the received frames are less than the framerate, display 586 or FRC unit 400 may duplicate one or more of the frames in a frame buffer during playback to achieve the operational framerate.

FIG. 10B depicts video capture device 590, which includes camera 592, FRC unit 594, and video encoder 596. Camera 592 may capture video data at a certain framerate. Camera 592 provides the captured frames to FRC unit 594. FRC unit 594 may perform the techniques of this disclosure to dynamically interpolate a number of frames between two consecutive frames received from camera 592, e.g., based on an amount of motion between the two consecutive frames. FRC unit 594 may then provide the received frames and the interpolated frames to video encoder 596, which may encode the frames according to a video coding standard. Video encoder 596 may in some examples, provide an indication of a number of interpolated frames in high-level syntax (HLS) data, such as a sequence parameter set (SPS), picture parameter set (PPS), or supplemental enhancement information (SEI) message, indicating a number of interpolated frames between a pair of captured frames, which may allow for duplication of frames to achieve an operational framerate by a video decoder or other downstream video processing device.

FIG. 10C depicts playback device 600. In this example, playback device 600 includes an artificial intelligence/machine learning (AI/ML) video decoder 602. That is, rather than a video decoder that operates according to a predefined standard, such as ITU-T H.264, H.265, H.266, or the like, AI/ML video decoder 602 may operate according to an AI/ML model trained to decode video data. A corresponding video encoder may also operate according to a corresponding AI/ML model trained to encode video data. After AI/ML video decoder 602 decodes two consecutive frames of video data, FRC unit 604 may perform the techniques of this disclosure to dynamically determine a number of frames to interpolate between the two consecutive frames. FRC unit 604 may provide the received frames and the interpolated frames to display 606, which may be configured as discussed with respect to display 586 to achieve the operational framerate.

Various examples of the techniques of this disclosure are summarized in the following clauses:

Clause 1: A method of upconverting video data, the method comprising: determining an amount of motion between a region of a first frame of video data and a corresponding region of a second frame of the video data; determining a number of frames to interpolate between the first frame and the second frame according to the amount of motion; and interpolating the determined number of frames to upconvert the video data.

Clause 2: The method of clause 1, wherein determining the amount of motion comprises performing a motion search to generate a motion vector for the region of the first frame such that the motion vector identifies the corresponding region of the second frame relative to the region of the first frame.

Clause 3: The method of clause 2, wherein performing the motion search comprises: performing the motion search on the entire first frame relative to the second frame to generate a plurality of motion vectors; and determining that the motion vector for the region is a largest motion vector of the plurality of motion vectors.

Clause 4: The method of clause 1, wherein determining the number of frames to interpolate comprises: comparing the amount of motion to a threshold; and when the amount of motion is less than the threshold, determining a first number of frames to interpolate, or when the amount of motion is greater than the threshold, determining a second number of frames to interpolate.

Clause 5: The method of clause 1, wherein determining the number of frames to interpolate comprises: determining a plurality of threshold values, each of the threshold values being different and being mapped to a respective number of frames to interpolate; determining a largest threshold value of the plurality of threshold values that the amount of motion exceeds; and determining that the number of frames to interpolate is equal to the number of frames to interpolate to which the largest threshold value that the amount of motion exceeds is mapped.

Clause 6: The method of clause 1, wherein determining the number of frames to interpolate comprises: when the amount of motion exceeds a first threshold but not a second threshold larger than the first threshold, determining the number of frames to interpolate is equal to 1, when the amount of motion exceeds the second threshold but not a third threshold larger than the second threshold, determining the number of frames to interpolate is equal to 2, or when the amount of motion exceeds the third threshold, determining the number of frames to interpolate is equal to 3.

Clause 7: The method of clause 1, further comprising decoding the first frame and the second frame prior to determining the amount of motion.

Clause 8: The method of clause 1, further comprising generating the first frame and the second frame prior to determining the amount of motion.

Clause 9: A device for upconverting video data, the device comprising: a memory configured to store video data; and a processing system comprising one or more processors implemented in circuitry, the processing system being configured to: determine an amount of motion between a region of a first frame of the video data and a corresponding region of a second frame of the video data; determine a number of frames to interpolate between the first frame and the second frame according to the amount of motion; and interpolate the determined number of frames to upconvert the video data.

Clause 10: The device of clause 9, wherein to determine the amount of motion, the processing system is configured to perform a motion search to generate a motion vector for the region of the first frame such that the motion vector identifies the corresponding region of the second frame relative to the region of the first frame.

Clause 11: The device of clause 10, wherein to performing the motion search, the processing system is configured to: perform the motion search on the entire first frame relative to the second frame to generate a plurality of motion vectors; and determine that the motion vector for the region is a largest motion vector of the plurality of motion vectors.

Clause 12: The device of clause 9, wherein to determine the number of frames to interpolate, the processing system is configured to: compare the amount of motion to a threshold; and when the amount of motion is less than the threshold, determine a first number of frames to interpolate, or when the amount of motion is greater than the threshold, determine a second number of frames to interpolate.

Clause 13: The device of clause 9, wherein to determine the number of frames to interpolate, the processing system is configured to: determine a plurality of threshold values, each of the threshold values being different and being mapped to a respective number of frames to interpolate; determine a largest threshold value of the plurality of threshold values that the amount of motion exceeds; and determine that the number of frames to interpolate is equal to the number of frames to interpolate to which the largest threshold value that the amount of motion exceeds is mapped.

Clause 14: The device of clause 9, wherein to determine the number of frames to interpolate, the processing system is configured to: when the amount of motion exceeds a first threshold but not a second threshold larger than the first threshold, determine that the number of frames to interpolate is equal to 1, when the amount of motion exceeds the second threshold but not a third threshold larger than the second threshold, determine that the number of frames to interpolate is equal to 2, or when the amount of motion exceeds the third threshold, determine that the number of frames to interpolate is equal to 3.

Clause 15: The device of clause 9, further comprising a video decoder configured to decode the first frame and the second frame.

Clause 16: The device of clause 9, further comprising a graphics engine configured to generate the first frame and the second frame.

Clause 17: The device of clause 9, further comprising a display configured to display the first frame, the second frame, and the interpolated frames.

Clause 18: The device of clause 9, wherein the device comprises one or more of a camera, a computer, a mobile device, a broadcast receiver device, or a set-top box.

Clause 19: A computer-readable storage medium having stored thereon instructions that, when executed, cause a processing system to: determine an amount of motion between a region of a first frame of video data and a corresponding region of a second frame of the video data; determine a number of frames to interpolate between the first frame and the second frame according to the amount of motion; and interpolate the determined number of frames to upconvert the video data.

Clause 20: The computer-readable storage medium of clause 19, wherein the instructions that cause the processing system to determine the amount of motion comprise instructions that cause the processing system to perform a motion search to generate a motion vector for the region of the first frame such that the motion vector identifies the corresponding region of the second frame relative to the region of the first frame.

Clause 21: The computer-readable storage medium of clause 20, wherein the instructions that cause the processing system to perform the motion search comprise instructions that cause the processing system to: perform the motion search on the entire first frame relative to the second frame to generate a plurality of motion vectors; and determine that the motion vector for the region is a largest motion vector of the plurality of motion vectors.

Clause 22: The computer-readable storage medium of clause 19, wherein the instructions that cause the processing system to determine the number of frames to interpolate comprise instructions that cause the processing system to: compare the amount of motion to a threshold; and when the amount of motion is less than the threshold, determine a first number of frames to interpolate, or when the amount of motion is greater than the threshold, determine a second number of frames to interpolate.

Clause 23: The computer-readable storage medium of clause 19, wherein the instructions that cause the processing system to determine the number of frames to interpolate comprise instructions that cause the processing system to: determine a plurality of threshold values, each of the threshold values being different and being mapped to a respective number of frames to interpolate; determine a largest threshold value of the plurality of threshold values that the amount of motion exceeds; and determine that the number of frames to interpolate is equal to the number of frames to interpolate to which the largest threshold value that the amount of motion exceeds is mapped.

Clause 24: The computer-readable storage medium of clause 19, wherein the instructions that cause the processing system to determine the number of frames to interpolate comprise instructions that cause the processing system to: when the amount of motion exceeds a first threshold but not a second threshold larger than the first threshold, determine the number of frames to interpolate is equal to 1, when the amount of motion exceeds the second threshold but not a third threshold larger than the second threshold, determine the number of frames to interpolate is equal to 2, or when the amount of motion exceeds the third threshold, determine the number of frames to interpolate is equal to 3.

Clause 25: The computer-readable storage medium of clause 19, further comprising instructions that cause the processing system to decode the first frame and the second frame prior to the determination of the amount of motion.

Clause 26: The computer-readable storage medium of clause 19, further comprising instructions that cause the processing system to generate the first frame and the second frame prior to the determination of the amount of motion.

Clause 27: A device for upconverting video data, the device comprising: means for determining an amount of motion between a region of a first frame of video data and a corresponding region of a second frame of the video data; means for determining a number of frames to interpolate between the first frame and the second frame according to the amount of motion; and means for interpolating the determined number of frames to upconvert the video data.

Clause 28: The device of clause 27, wherein the means for determining the amount of motion comprises means for performing a motion search to generate a motion vector for the region of the first frame such that the motion vector identifies the corresponding region of the second frame relative to the region of the first frame.

Clause 29: The device of clause 28, wherein the means for performing the motion search comprises: means for performing the motion search on the entire first frame relative to the second frame to generate a plurality of motion vectors; and means for determining that the motion vector for the region is a largest motion vector of the plurality of motion vectors.

Clause 30: The device of clause 27, wherein the means for determining the number of frames to interpolate comprises: means for comparing the amount of motion to a threshold; means for determining a first number of frames to interpolate when the amount of motion is less than the threshold; and means for determining a second number of frames to interpolate when the amount of motion is greater than the threshold.

Clause 31: The device of clause 27, wherein the means for determining the number of frames to interpolate comprises: means for determining a plurality of threshold values, each of the threshold values being different and being mapped to a respective number of frames to interpolate; means for determining a largest threshold value of the plurality of threshold values that the amount of motion exceeds; and means for determining that the number of frames to interpolate is equal to the number of frames to interpolate to which the largest threshold value that the amount of motion exceeds is mapped.

Clause 32: The device of clause 27, wherein the means for determining the number of frames to interpolate comprises: means for determining the number of frames to interpolate is equal to 1 when the amount of motion exceeds a first threshold but not a second threshold larger than the first threshold; means for determining the number of frames to interpolate is equal to 2 when the amount of motion exceeds the second threshold but not a third threshold larger than the second threshold; and means for determining the number of frames to interpolate is equal to 3 when the amount of motion exceeds the third threshold.

Clause 33: The device of clause 27, further comprising means for decoding the first frame and the second frame prior to determining the amount of motion.

Clause 34: The device of clause 27, further comprising means for generating the first frame and the second frame prior to determining the amount of motion.

Clause 35: A method of upconverting video data, the method comprising: determining an amount of motion between a region of a first frame of video data and a corresponding region of a second frame of the video data; determining a number of frames to interpolate between the first frame and the second frame according to the amount of motion; and interpolating the determined number of frames to upconvert the video data.

Clause 36: The method of clause 35, wherein determining the amount of motion comprises performing a motion search to generate a motion vector for the region of the first frame such that the motion vector identifies the corresponding region of the second frame relative to the region of the first frame.

Clause 37: The method of clause 36, wherein performing the motion search comprises: performing the motion search on the entire first frame relative to the second frame to generate a plurality of motion vectors; and determining that the motion vector for the region is a largest motion vector of the plurality of motion vectors.

Clause 38: The method of any of clauses 35-37, wherein determining the number of frames to interpolate comprises: comparing the amount of motion to a threshold; and when the amount of motion is less than the threshold, determining a first number of frames to interpolate, or when the amount of motion is greater than the threshold, determining a second number of frames to interpolate.

Clause 39: The method of any of clauses 35-37, wherein determining the number of frames to interpolate comprises: determining a plurality of threshold values, each of the threshold values being different and being mapped to a respective number of frames to interpolate; determining a largest threshold value of the plurality of threshold values that the amount of motion exceeds; and determining that the number of frames to interpolate is equal to the number of frames to interpolate to which the largest threshold value that the amount of motion exceeds is mapped.

Clause 40: The method of any of clauses 35-37, wherein determining the number of frames to interpolate comprises: when the amount of motion exceeds a first threshold but not a second threshold larger than the first threshold, determining the number of frames to interpolate is equal to 1, when the amount of motion exceeds the second threshold but not a third threshold larger than the second threshold, determining the number of frames to interpolate is equal to 2, or when the amount of motion exceeds the third threshold, determining the number of frames to interpolate is equal to 3.

Clause 41: The method of any of clauses 35-40, further comprising decoding the first frame and the second frame prior to determining the amount of motion.

Clause 42: The method of any of clauses 35-40, further comprising generating the first frame and the second frame prior to determining the amount of motion.

Clause 43: A device for upconverting video data, the device comprising: a memory configured to store video data; and a processing system comprising one or more processors implemented in circuitry, the processing system being configured to: determine an amount of motion between a region of a first frame of the video data and a corresponding region of a second frame of the video data; determine a number of frames to interpolate between the first frame and the second frame according to the amount of motion; and interpolate the determined number of frames to upconvert the video data.

Clause 44: The device of clause 43, wherein to determine the amount of motion, the processing system is configured to perform a motion search to generate a motion vector for the region of the first frame such that the motion vector identifies the corresponding region of the second frame relative to the region of the first frame.

Clause 45: The device of clause 44, wherein to performing the motion search, the processing system is configured to: perform the motion search on the entire first frame relative to the second frame to generate a plurality of motion vectors; and determine that the motion vector for the region is a largest motion vector of the plurality of motion vectors.

Clause 46: The device of any of clauses 43-45, wherein to determine the number of frames to interpolate, the processing system is configured to: compare the amount of motion to a threshold; and when the amount of motion is less than the threshold, determine a first number of frames to interpolate, or when the amount of motion is greater than the threshold, determine a second number of frames to interpolate.

Clause 47: The device of any of clauses 43-45, wherein to determine the number of frames to interpolate, the processing system is configured to: determine a plurality of threshold values, each of the threshold values being different and being mapped to a respective number of frames to interpolate; determine a largest threshold value of the plurality of threshold values that the amount of motion exceeds; and determine that the number of frames to interpolate is equal to the number of frames to interpolate to which the largest threshold value that the amount of motion exceeds is mapped.

Clause 48: The device of any of clauses 43-45, wherein to determine the number of frames to interpolate, the processing system is configured to: when the amount of motion exceeds a first threshold but not a second threshold larger than the first threshold, determine that the number of frames to interpolate is equal to 1, when the amount of motion exceeds the second threshold but not a third threshold larger than the second threshold, determine that the number of frames to interpolate is equal to 2, or when the amount of motion exceeds the third threshold, determine that the number of frames to interpolate is equal to 3.

Clause 49: The device of any of clauses 43-48, further comprising a video decoder configured to decode the first frame and the second frame.

Clause 50: The device of any of clauses 43-48, further comprising a graphics engine configured to generate the first frame and the second frame.

Clause 51: The device of any of clauses 43-50, further comprising a display configured to display the first frame, the second frame, and the interpolated frames.

Clause 52: The device of any of clauses 43-51, wherein the device comprises one or more of a camera, a computer, a mobile device, a broadcast receiver device, or a set-top box.

Clause 53: A computer-readable storage medium having stored thereon instructions that, when executed, cause a processing system to: determine an amount of motion between a region of a first frame of video data and a corresponding region of a second frame of the video data; determine a number of frames to interpolate between the first frame and the second frame according to the amount of motion; and interpolate the determined number of frames to upconvert the video data.

Clause 54: The computer-readable storage medium of clause 53, wherein the instructions that cause the processing system to determine the amount of motion comprise instructions that cause the processing system to perform a motion search to generate a motion vector for the region of the first frame such that the motion vector identifies the corresponding region of the second frame relative to the region of the first frame.

Clause 55: The computer-readable storage medium of clause 54, wherein the instructions that cause the processing system to perform the motion search comprise instructions that cause the processing system to: perform the motion search on the entire first frame relative to the second frame to generate a plurality of motion vectors; and determine that the motion vector for the region is a largest motion vector of the plurality of motion vectors.

Clause 56: The computer-readable storage medium of any of clauses 53-55, wherein the instructions that cause the processing system to determine the number of frames to interpolate comprise instructions that cause the processing system to: compare the amount of motion to a threshold; and when the amount of motion is less than the threshold, determine a first number of frames to interpolate, or when the amount of motion is greater than the threshold, determine a second number of frames to interpolate.

Clause 57: The computer-readable storage medium of any of clauses 53-55, wherein the instructions that cause the processing system to determine the number of frames to interpolate comprise instructions that cause the processing system to: determine a plurality of threshold values, each of the threshold values being different and being mapped to a respective number of frames to interpolate; determine a largest threshold value of the plurality of threshold values that the amount of motion exceeds; and determine that the number of frames to interpolate is equal to the number of frames to interpolate to which the largest threshold value that the amount of motion exceeds is mapped.

Clause 58: The computer-readable storage medium of any of clauses 53-55, wherein the instructions that cause the processing system to determine the number of frames to interpolate comprise instructions that cause the processing system to: when the amount of motion exceeds a first threshold but not a second threshold larger than the first threshold, determine the number of frames to interpolate is equal to 1, when the amount of motion exceeds the second threshold but not a third threshold larger than the second threshold, determine the number of frames to interpolate is equal to 2, or when the amount of motion exceeds the third threshold, determine the number of frames to interpolate is equal to 3.

Clause 59: The computer-readable storage medium of any of clauses 53-58, further comprising instructions that cause the processing system to decode the first frame and the second frame prior to the determination of the amount of motion.

Clause 60: The computer-readable storage medium of any of clauses 53-58, further comprising instructions that cause the processing system to generate the first frame and the second frame prior to the determination of the amount of motion.

Clause 61: A device for upconverting video data, the device comprising: means for determining an amount of motion between a region of a first frame of video data and a corresponding region of a second frame of the video data; means for determining a number of frames to interpolate between the first frame and the second frame according to the amount of motion; and means for interpolating the determined number of frames to upconvert the video data.

Clause 62: The device of clause 61, wherein the means for determining the amount of motion comprises means for performing a motion search to generate a motion vector for the region of the first frame such that the motion vector identifies the corresponding region of the second frame relative to the region of the first frame.

Clause 63: The device of clause 62, wherein the means for performing the motion search comprises: means for performing the motion search on the entire first frame relative to the second frame to generate a plurality of motion vectors; and means for determining that the motion vector for the region is a largest motion vector of the plurality of motion vectors.

Clause 64: The device of any of clauses 61-63, wherein the means for determining the number of frames to interpolate comprises: means for comparing the amount of motion to a threshold; means for determining a first number of frames to interpolate when the amount of motion is less than the threshold; and means for determining a second number of frames to interpolate when the amount of motion is greater than the threshold.

Clause 65: The device of any of clauses 61-63, wherein the means for determining the number of frames to interpolate comprises: means for determining a plurality of threshold values, each of the threshold values being different and being mapped to a respective number of frames to interpolate; means for determining a largest threshold value of the plurality of threshold values that the amount of motion exceeds; and means for determining that the number of frames to interpolate is equal to the number of frames to interpolate to which the largest threshold value that the amount of motion exceeds is mapped.

Clause 66: The device of any of clauses 61-63, wherein the means for determining the number of frames to interpolate comprises: means for determining the number of frames to interpolate is equal to 1 when the amount of motion exceeds a first threshold but not a second threshold larger than the first threshold; means for determining the number of frames to interpolate is equal to 2 when the amount of motion exceeds the second threshold but not a third threshold larger than the second threshold; and means for determining the number of frames to interpolate is equal to 3 when the amount of motion exceeds the third threshold.

Clause 67: The device of any of clauses 61-66, further comprising means for decoding the first frame and the second frame prior to determining the amount of motion.

Clause 68: The device of any of clauses 61-66, further comprising means for generating the first frame and the second frame prior to determining the amount of motion.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of upconverting video data, the method comprising:
determining an amount of motion between a region of a first frame of video data and a corresponding region of a second frame of the video data;
determining a number of frames to interpolate between the first frame and the second frame according to the amount of motion; and
interpolating the determined number of frames to upconvert the video data.

2. The method of claim 1, wherein determining the amount of motion comprises performing a motion search to generate a motion vector for the region of the first frame such that the motion vector identifies the corresponding region of the second frame relative to the region of the first frame.

3. The method of claim 2, wherein performing the motion search comprises:
performing the motion search on the first frame relative to the second frame to generate a plurality of motion vectors; and
determining that the region corresponds to a largest motion vector of the plurality motion vectors.

4. The method of claim 2, wherein determining the amount of motion comprises:
performing the motion search on the first frame relative to the second frame to generate a plurality of motion vectors; and
generating a histogram including bins representing different lengths of motion vectors and values representing a number of the plurality of motion vectors included in each bin.

5. The method of claim 4, wherein determining the number of frames to interpolate comprises determining the number of frames to interpolate according to a profile for the histogram.

6. The method of claim 1, wherein determining the number of frames to interpolate comprises:
comparing the amount of motion to a threshold; and
when the amount of motion is less than the threshold, determining a first number of frames to interpolate, or
when the amount of motion is greater than the threshold, determining a second number of frames to interpolate.

7. The method of claim 1, wherein determining the number of frames to interpolate comprises:
determining a plurality of threshold values, each of the threshold values being different and being mapped to a respective number of frames to interpolate;
determining a largest threshold value of the plurality of threshold values that the amount of motion exceeds; and
determining that the number of frames to interpolate is equal to the number of frames to interpolate to which the largest threshold value that the amount of motion exceeds is mapped.

8. The method of claim 1, wherein determining the number of frames to interpolate comprises:
when the amount of motion exceeds a first threshold but not a second threshold larger than the first threshold, determining the number of frames to interpolate is equal to 1,
when the amount of motion exceeds the second threshold but not a third threshold larger than the second threshold, determining the number of frames to interpolate is equal to 2, or
when the amount of motion exceeds the third threshold, determining the number of frames to interpolate is equal to 3.

9. The method of claim 1, further comprising decoding the first frame and the second frame prior to determining the amount of motion.

10. The method of claim 1, further comprising generating the first frame and the second frame prior to determining the amount of motion.

11. A device for upconverting video data, the device comprising:
a memory configured to store video data; and
a processing system comprising one or more processors implemented in circuitry, the processing system being configured to:
determine an amount of motion between a region of a first frame of the video data and a corresponding region of a second frame of the video data;
determine a number of frames to interpolate between the first frame and the second frame according to the amount of motion; and
interpolate the determined number of frames to upconvert the video data.

12. The device of claim 11, wherein to determine the amount of motion, the processing system is configured to perform a motion search to generate a motion vector for the region of the first frame such that the motion vector identifies the corresponding region of the second frame relative to the region of the first frame.

13. The device of claim 12, wherein to performing the motion search, the processing system is configured to:
perform the motion search on the first frame relative to the second frame to generate a plurality of motion vectors; and
determine that the region corresponds to a largest motion vector of the plurality of motion vectors.

14. The device of claim 12, wherein to performing the motion search, the processing system is configured to:
perform the motion search on the first frame relative to the second frame to generate a plurality of motion vectors; and
generate a histogram including bins representing different lengths of motion vectors and values representing a number of the plurality of motion vectors included in each bin.

15. The device of claim 11, wherein to determine the number of frames to interpolate, the processing system is configured to:
compare the amount of motion to a threshold; and
when the amount of motion is less than the threshold, determine a first number of frames to interpolate, or
when the amount of motion is greater than the threshold, determine a second number of frames to interpolate.

16. The device of claim 11, wherein to determine the number of frames to interpolate, the processing system is configured to:
determine a plurality of threshold values, each of the threshold values being different and being mapped to a respective number of frames to interpolate;
determine a largest threshold value of the plurality of threshold values that the amount of motion exceeds; and
determine that the number of frames to interpolate is equal to the number of frames to interpolate to which the largest threshold value that the amount of motion exceeds is mapped.

17. The device of claim 11, wherein to determine the number of frames to interpolate, the processing system is configured to:
when the amount of motion exceeds a first threshold but not a second threshold larger than the first threshold, determine that the number of frames to interpolate is equal to 1,
when the amount of motion exceeds the second threshold but not a third threshold larger than the second threshold, determine that the number of frames to interpolate is equal to 2, or
when the amount of motion exceeds the third threshold, determine that the number of frames to interpolate is equal to 3.

18. The device of claim 11, further comprising a video decoder configured to decode the first frame and the second frame.

19. The device of claim 11, further comprising a graphics engine configured to generate the first frame and the second frame.

20. The device of claim 11, further comprising a display configured to display the first frame, the second frame, and the interpolated frames.

21. The device of claim 11, wherein the device comprises one or more of a camera, a computer, a mobile device, a broadcast receiver device, or a set-top box.

22. A computer-readable storage medium having stored thereon instructions that, when executed, cause a processing system to:
determine an amount of motion between a region of a first frame of video data and a corresponding region of a second frame of the video data;
determine a number of frames to interpolate between the first frame and the second frame according to the amount of motion; and
interpolate the determined number of frames to upconvert the video data.

23. The computer-readable storage medium of claim 22, wherein the instructions that cause the processing system to determine the amount of motion comprise instructions that cause the processing system to perform a motion search to generate a motion vector for the region of the first frame such that the motion vector identifies the corresponding region of the second frame relative to the region of the first frame.

24. The computer-readable storage medium of claim 23, wherein the instructions that cause the processing system to perform the motion search comprise instructions that cause the processing system to:
perform the motion search on the entire first frame relative to the second frame to generate a plurality of motion vectors; and
determine that the motion vector for the region is a largest motion vector of the plurality of motion vectors.

25. The computer-readable storage medium of claim 23, wherein the instructions that cause the processing system to perform the motion search comprise instructions that cause the processing system to:
perform the motion search on the first frame relative to the second frame to generate a plurality of motion vectors; and
generate a histogram including bins representing different lengths of motion vectors and values representing a number of the plurality of motion vectors included in each bin.

26. A device for upconverting video data, the device comprising:
means for determining an amount of motion between a region of a first frame of video data and a corresponding region of a second frame of the video data;
means for determining a number of frames to interpolate between the first frame and the second frame according to the amount of motion; and
means for interpolating the determined number of frames to upconvert the video data.

27. The device of claim 26, wherein the means for determining the amount of motion comprises means for performing a motion search to generate a motion vector for the region of the first frame such that the motion vector identifies the corresponding region of the second frame relative to the region of the first frame.

28. The device of claim 27, wherein the means for performing the motion search comprises:
means for performing the motion search on the entire first frame relative to the second frame to generate a plurality of motion vectors; and
means for determining that the motion vector for the region is a largest motion vector of the plurality of motion vectors.

29. The device of claim 27, wherein the means for performing the motion search comprises:
means for performing the motion search on the entire first frame relative to the second frame to generate a plurality of motion vectors; and
means for generating a histogram including bins representing different lengths of motion vectors and values representing a number of the plurality of motion vectors included in each bin.

30. The device of claim 26, wherein the means for determining the number of frames to interpolate comprises:
means for comparing the amount of motion to a threshold; and
means for determining a first number of frames to interpolate when the amount of motion is less than the threshold; and
means for determining a second number of frames to interpolate when the amount of motion is greater than the threshold.
